(19) United States
(12) Patent Application Publication
(10) Pub. No.: US 2013/0326271 A1
(43) Pub. Date: Dec. 5, 2013

(54) HANDLING OF INITIALLY UNEXECUTABLE INSTRUCTIONS

(71) Applicant: Scott E. Petersen, San Jose, CA (US)

(72) Inventor: Scott E. Petersen, San Jose, CA (US)

(21) Appl. No.: 12/756,806

(22) Filed: Apr. 8, 2010

(51) Int. Cl. G06F 11/07

(52) U.S. Cl. 714/15; 714/E11.023

(57) ABSTRACT

According to example configurations, a monitor resource monitors hardware executing a software program. In response to detecting occurrence of a failure associated with an attempted execution of a given software instruction in the software program, the hardware generates a notification. The monitor resource receives the signal generated by the hardware. In response to receiving the signal, the monitor resource initiates computation of the data value associated with the given software instruction. For example, via a communication from the monitor resource to the hardware executing the software program, the monitor resource initiates computation of the value associated with the given instruction by directing the hardware to initiate execution of a specific routine. By way of example, the monitor resource can initiate a lazy computation based on execution of a fault handling function or subroutine to compute a value for the failed instruction.

### BACKGROUND

Conventional software applications sometimes implement code to perform a function known as lazy computing. In general, lazy computing involves computing a value at run time when the value associated with the variable is first needed by software.

One conventional way of implementing lazy computing is to initialize a flag in software to a predetermined value to indicate that the value for a given variable has not yet been computed. During execution, the software program can implement if-then-else type instructions to initiate a computation of a value if a value for the variable has not yet been computed. Subsequent to computing a value for the variable, the software program sets the flag to indicate that the variable already has been computed. Accordingly, on a subsequent access to the variable, based on execution of if-then type instructions, the program will detect that a value for the variable has already been computed based on a setting of the flag and use the computed value rather than recompute the value from scratch.

Another conventional way of implementing lazy computing in a software program is to include a variable that holds a computation function. Upon first access to the variable during execution of the software program, the software program initiates execution of the computation function to determine an appropriate value for the variable. Subsequent to execution of the computation function, the software program replaces the original computation function with a new function that is configured to return the computed value when the variable is subsequently accessed. Accordingly, based on this conventional technique, there is no need to re-compute the value for the variable upon a subsequent access.

Yet another, although less commonly implemented, conventional way of lazy computing is to initiate rewriting of the executable code during run-time via self-modifying code. According to this conventional technique, the self-modifying code generates native code including first generated executable code to carry out a lazy computation. Subsequent to performing a computation of a value, the self-modifying code rewrites or modifies the native executable code such that the computation is not performed again on subsequent passes.

### BRIEF DESCRIPTION

Conventional techniques of lazy computing as discussed above can suffer from a number of deficiencies. For example, for the first two conventional methods as mentioned above, implementing lazy value computation requires additional instructions in a software program. Thus, lazy value computation can result in a larger sized software application. Execution of the additional instructions in a software application requires processing time and thus can slow down execution of a software program.

In the latter mentioned conventional lazy computation technique, implementation of self-modifying code via a just-in-time compiler can be very complex. Accordingly, the conventional techniques as discussed above for implementing lazy computing may be undesirable for certain applications.

Embodiments herein deviate with respect to conventional lazy value computation techniques.

For example, one embodiment herein includes a monitor resource configured to monitor hardware such as one or more processor devices that execute code or instructions in a software program. In response to detecting occurrence of a failure associated with an attempted execution of a given software instruction in the software program, the hardware generates a failure notification.

In one embodiment, the software program includes an instruction to retrieve data from an invalid storage location such as a memory location. In response to detecting that the storage location for retrieving the data is invalid, the hardware generates a signal such as a failure notification.

The monitor resource receives the signal generated by the hardware. In response to receiving the signal such as a failure notification, the monitor resource initiates computation of the data value associated with the given software instruction. For example, in one embodiment, via a communication from the monitor resource to the hardware executing the software program, the monitor resource initiates computation of the value associated with the given instruction by directing the hardware to initiate execution of a specific routine. By way of a non-limiting example, the monitor resource can initiate execution of a specific portion of the software program such as a fault handling function or subroutine to compute a value for the failed instruction.

By way of a further non-limiting example, in accordance with one embodiment, the monitor resource initiates steps of: mapping variable associated with the failed instruction to a valid storage location, computing the value associated with the given instruction, and storing the computed value in the mapped storage location.

Thus, in accordance with embodiments herein, signals such as exceptions generated by hardware can be used to avoid the need for heavy overhead processing and/or software instructions to check whether a lazy computation has been performed. In other words, one embodiment herein allows lazy value computation without having to include inline code such as conditionally executed instructions such as if-then type instructions in a software program to explicitly check for the existence of an already-computed value or to compute a value if it has not already been computed. Instead, upon accessing a variable from an invalid storage location, embodiments herein include computing a value for the variable and storing the computed value in a valid storage location associated with the variable.

These and other embodiment variations are discussed in more detail below.

As mentioned above, note that embodiments herein can include a configuration of one or more computerized devices, workstations, handheld or laptop computers, or the like to carry out and/or support any or all of the method operations disclosed herein. In other words, one or more computerized devices or processors can be programmed and/or configured to operate as explained herein to carry out different embodiments of the invention.

Yet other embodiments herein include software programs to perform the steps and operations summarized above and disclosed in detail below. One such embodiment comprises a computer program product that has a computer-storage medium including computer program logic encoded thereon that, when performed in a computerized device having a processor and corresponding memory, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein.

Accordingly, one particular embodiment of the present disclosure is directed to a computer program product that includes a computer readable medium having instructions stored thereon for supporting operations such as handling of event notifications generated based on an inability to carry out a software instruction. For example, in one embodiment, the instructions, when carried out by a processor of a respective computer device, cause the processor in a monitor resource to: monitor hardware, the hardware executing software instructions in a software program; receive a notification generated by the hardware, the notification indicating a failure associated with an attempted execution of a given software instruction in the software program; and in response to receiving the notification, initiate computation of a value associated with the given software instruction.

The ordering of the steps has been added for clarity sake. These steps can be performed in any suitable order.

Other embodiments of the present disclosure include software programs and/or respective hardware to perform any of the method embodiment steps and operations summarized above and disclosed in detail below.

Also, it is to be understood that the system, method, apparatus, instructions on computer readable storage media, etc., as discussed herein can be embodied strictly as a software program, as a hybrid of software and hardware, or as hardware alone such as within a processor, or within an operating system or a within a software application. Example embodiments of the invention may be implemented within products and/or software applications such as those manufactured by Adobe Systems Incorporated of San Jose, Calif., USA.

As discussed above, techniques herein are well suited for use in software and/or hardware applications that facilitate lazy computations. However, it should be noted that embodiments herein are not limited to use in such applications and that the techniques discussed herein are well suited for other applications as well.

Additionally, although each of the different features, techniques, configurations, etc., herein may be discussed in different places of this disclosure, it is intended that each of the concepts can be executed independently of each other or in combination with each other. Accordingly, the one or more present inventions as described herein can be embodied and viewed in many different ways.

Also, note that this preliminary discussion of embodiments herein does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section and corresponding figures of the present disclosure as further discussed below.

### BRIEF DESCRIPTION OF THE DRAWINGS

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

FIG. 1 is an example diagram of a computer environment supporting lazy computing according to embodiments herein.

FIG. 2 is an example diagram illustrating execution of instructions in a software program and computation of a value according to embodiments herein.

FIG. 3 is a diagram illustrating an example computer architecture for executing a software program according to embodiments herein.

FIG. 4 is a flowchart illustrating an example method of performing a lazy computation according to embodiments herein.

FIG. 5 is a flowchart illustrating a more specific example method of performing a computation associated with a failed instruction according to embodiments herein.

FIG. 6 is a flowchart illustrating a more specific example method of performing a computation according to embodiments herein.

FIGS. 7 and 8 combine to form a flowchart illustrating an example method of initiating execution of instructions to handle a fault according to embodiments herein.

### DETAILED DESCRIPTION

According to example configurations as described herein, a software program includes multiple instructions executed by a processor resource. The processor resource detects an error when executing a given instruction in the software program. For example, when executing the given instruction, the processor resource attempts to access stored data. Upon detecting an inability to retrieve stored data associated with the given instruction, the processor resource generates a notification.

In one embodiment, a monitor resource receives the notification and initiates: mapping of a variable associated with the given instruction to a valid storage location, computation of a value, and storage of the value in the valid storage location. On a subsequent execution of the given instruction in the software program, the processor resource is able to successfully access the value from the valid storage location without occurrence of access failure.

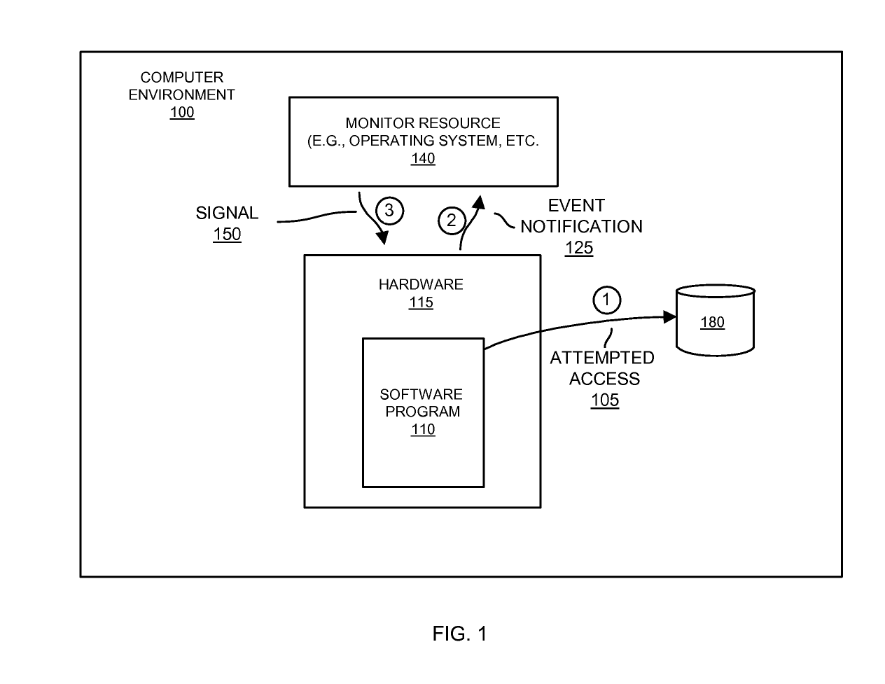

FIG. 1 is an example diagram illustrating a computer environment 100 according to embodiments herein.

As shown, computer environment 100 includes hardware 115 such as one or more processor devices to execute instructions such as executable code, software instructions, etc., in software program 110.

Computer environment 100 can include a monitor resource 140 such as an operating system or other hardware or software resource configured to perform operations as discussed herein.

According to general embodiments, the monitor resource 140 monitors hardware 115. Hardware 115 executes the instructions in software program 110.

During a first execution of a given instruction in the software program 110, the hardware 115 attempts to access data in accordance with the given instruction. The hardware 115, without checking or knowing otherwise, assumes that the instruction is executable and that any lazy evaluations or computations, if any, have already been performed for the given instruction.

In this example embodiment, assume that the initial execution of the given instruction or, more specifically, the corresponding attempted access 105 to data results in an execution error.

In one embodiment, execution of the given instruction can result in an attempt to retrieve data stored at an invalid storage location as specified by the given software instruction.

Occurrence of the execution error can result in an exception because a so-called lazy evaluation or computation has not yet been performed for an argument as specified in the given instruction.

In response to detecting a failure or inability to properly execute the given instruction, the hardware 115 generates event notification 125.

The monitor resource 140 receives the event notification 125. For example, in one embodiment, monitor resource 140 receives the notification 125 in response to the hardware detecting a condition such as an inability to access data from a storage location as specified by the given software instruction.

By way of a non-limiting example, the event notification 125 can include information such as data indicating the failure associated with given software instruction or inability of the hardware to carry out execution of the given software instruction. Accordingly, the monitor resource 140 can be notified of the failed attempt to execute given software instruction.

As its name suggests, the monitor resource 140 performs monitoring functions. For example, the monitor resource 140 monitors the hardware 115 executing software instructions in software program 110 and receives the event notification 125 as previously discussed.

In accordance with one embodiment, in response to receiving the event notification 125, the monitor resource 140 initiates computation of a value associated with the given software instruction.

For example, in one embodiment, in furtherance of carrying out execution of the given software instruction executing the given software instruction causing the event notification 125, the monitor resource 140 generates control signal 150 to perform an evaluation or computation associated with a variable or argument as specified by the given instruction. To perform a computation associated with the given instruction, the monitor resource 140 can cause or initiate execution of a set of instructions such as a function, subroutine, etc., to compute a value associated with the given instruction. Upon completion of the evaluation and/or repair associated with the given instruction, the hardware 115 resumes execution of the given software instruction.

In one embodiment, the hardware 115 receives signal 150 and initiates execution of a set of instructions at a specified location in the software program 110 itself to perform a computation and enable execution of the given instruction on a subsequent pass. Accordingly, on each subsequent attempt to carry out execution of the given instruction and because an appropriate computation was previously completed for the given instruction, as discussed above, the hardware 115 does not generate event notification 125 since it is possible to execute the instruction and perform a respective access to data without a failure.

One benefit of performing lazy computations in this manner is to alleviate a need to include instruction-based branches in the software program 110 to perform the lazy computations. Thus, software program 110 can be reduced in size in comparison to conventional techniques including instructional branches to perform lazy computations.

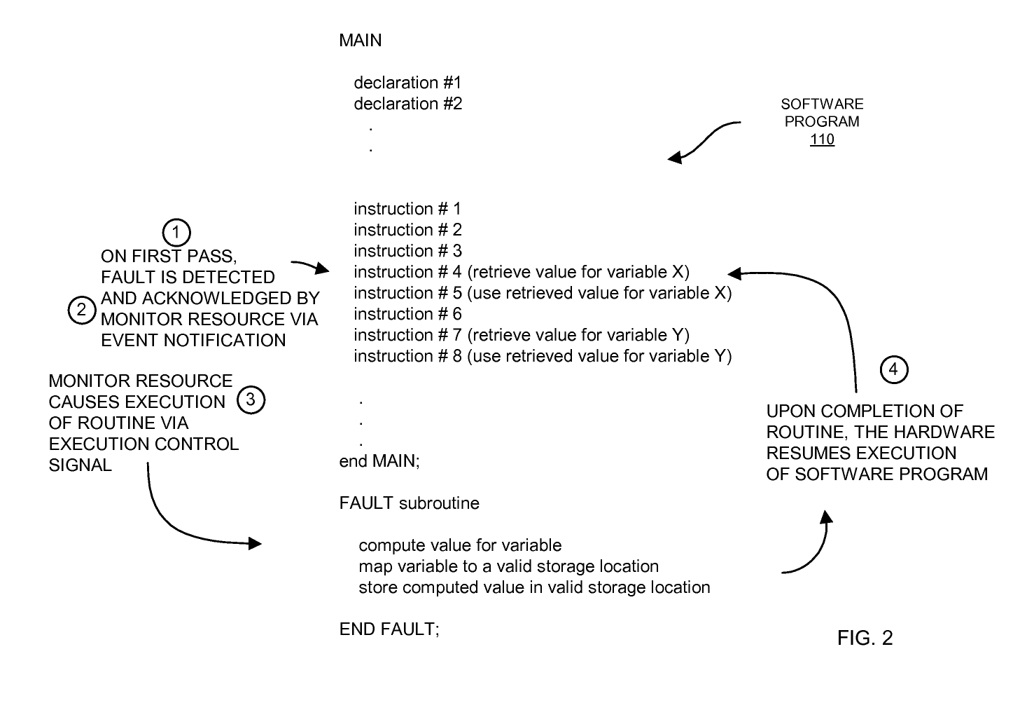

FIG. 2 is an example diagram illustrating a set of software instructions according to embodiments herein.

In this example, hardware 115 executes a sequence of instructions in software program 110 as shown.

Assume that instruction #4 represents an operation to retrieve a stored value but that a value associated with the instruction #4 has not yet been computed and/or a variable as specified by the instruction has not yet been mapped to a valid storage location.

Eventually, the hardware 115 attempts execution of instruction #4. Execution of instruction #4 results in a failure or exception as discussed above. Based on detecting this failure condition, the hardware 115 or other resource in computer environment 100 generates event notification 125.

Event notification 125 can be generated based on any number of different reasons depending on the embodiment. For example, in one embodiment, instruction #4 may indicate to retrieve data from an invalid storage location. Upon execution of instruction #4 in which the hardware 115 attempts retrieval of data from an invalid storage location, the hardware 115 generates event notification 125. Generation of the event notification may result in at least a temporarily termination of executing further instructions in the software program 110.

Based on the event notification 125, the monitor resource 140 generates a control signal 150 to handle the exception and/or failure. In one embodiment, the control signal 150 specifies a location such as set of instructions (e.g., FAULT subroutine) for execution by hardware 115 to correct the detected fault. The FAULT subroutine can be part of software program 110 or located in a different switch program.

Accordingly, embodiments herein can include: via a control signal 150 generated by a source (e.g., monitor resource 140) operating independently of the hardware 115 executing the software program, providing notification to the hardware 115 to execute code located at a particular location in the software program 110. As will be discussed below, the code at the particular location can be executed to compute a value associated with the given instruction and store the value in, for example, a memory location.

In such an embodiment, the resource monitor or fault handler proper does not compute the required value. Instead, the resource monitor configures the state of the faulting program (e.g., software program 110) such that, when resumed, it will be as if the faulting program had invoked a value computation subroutine. When execution of the FAULT subroutine finishes, execution of the software program 110 will “return” to where the fault occurred and the faulting instruction will be re-executed by the hardware 115. This is because in practice the fault handler may be meaningfully separate from the faulting application such that the handler can't (or shouldn't due to re-entrancy, etc.) try to do the actual value computation.

As an alternative to being part of software program 110, note that the FAULT subroutine can be another program or resource called upon by the monitor resource 140 to provide corrective measures or repair with respect to instruction #4 so that it can be executed on a subsequent attempt.

In one embodiment, in response to a communication of the control signal 150 from the monitor resource 140 to the hardware 115 executing the software program 110, the monitor resource 140 initiates computation of a value associated with the failed instruction by directing the hardware 115 to initiate execution of a specific routine such as a FAULT subroutine located in the software program 110. Thus, via signal 150, the monitor resource 140 can redirect the hardware 110 to execute code located at a particular location in the software program to rectify or repair attributes associated with the failed instruction.

Redirection by the monitor resource 140 (e.g., fault handler) can be based on any of a number of one or more parameters such as which instruction failed execution, a variable as specified by the given instruction, a general location in which the data should be stored, etc.

In one embodiment, the signal 150 indicates a pointer to a location to be executed by the hardware 110 to contingent execution after detecting the failure of the given instruction. Thus, in accordance with one embodiment, based on signal 150, the hardware 110 executes a set of instructions such as those in FAULT subroutine. Accordingly, embodiments herein can include receiving location information such as the specific location indicating where the error occurred in the software program and generating a redirect signal such as signal 150 to notify the hardware 110 to initiate execution of instructions at a location as specified by the location information subsequent to initiating computation of the value in the FAULT subroutine.

By way of a further non-limiting example, based on execution of the specified set of software instructions, the hardware 110 can map a variable associated with the given instruction that causes the failure to a valid storage location, compute a value associated with the variable in the given instruction, and store the computed value in the valid storage location.

In one embodiment, the hardware can keep track of where the failure or exception occurred in the software program 110. Upon completing execution of the subroutine, the hardware can continue with execution of the program where the error occurred. Thus, subsequent to computing the value for a given failed instruction, the subroutine can notify the hardware 110 or be used as a trigger to resume execution of the software program at the given software instruction upon completion.

In one embodiment, upon completing execution of instructions in the FAULT subroutine, the hardware 110 reattempts execution of instruction #4. Upon this subsequent attempt of executing instruction #4, the hardware 110 is able to retrieve the recently computed value from the valid storage location.

Subsequent to executing instruction #4, the hardware 115 can continue with execution of instructions in the software program 110. For example, the hardware 115 executes instruction #5. Instruction #5 uses the value retrieved from instruction #4.

Note that the software program 110 can include multiple instructions that initially fail or result in an exception during execution of software program 110.

For example, upon first execution, instruction #7 also can specify retrieval of data from an invalid storage location. In a similar manner as discussed above for instruction #4, the hardware 115 can generate an event notification in response to detecting an inability to execute instruction #7. The monitor resource 140 receives the notification generated by the hardware 110. The notification indicates a failure associated with an attempted execution of instruction #7 in the software program 110. The monitor resource 140, such as a resource operating independently of the hardware 110 executing the software instructions, generates a control signal. The monitor resource 140 communicates the control signal to the hardware 110 to indicate code at a particular location of the software program to be executed by the hardware 110.

In one embodiment, upon detection of the event notification associated with execution of instruction #7, the monitor resource 140 also initiates execution of FAULT subroutine as in FIG. 2 to handle the failure as discussed above. In such an embodiment, failures or exceptions for each of multiple instructions in the software program 110 can be handled by the same software function or subroutine.

As a possible alternative, the software program 110 can include multiple different exception handling subroutines. In such an embodiment, the monitor resource 140 can specify a different subroutine in the software program 110 or other resource to handle the exceptions depending on which instruction fails execution. Either way, a lazy computation can be performed for each of multiple instructions in the software program 110.

In a similar manner, as discussed above, via execution of the code at the particular location, the hardware 115 performs a computation of a value associated with software instruction #7, maps a variable in instruction #7 to a valid memory location, and initiates storage of the value in the valid memory location.

In one embodiment, subsequent to steps of computing, mapping, and storing the value for instruction #7, the monitor resource 140 notifies the hardware 115 to resume execution of the software program 110 in a vicinity of instruction #7. In one embodiment, the hardware 110 resumes or reattempts execution of instruction #7 after handling of the detected fault. The second attempt will not result in an exception as the instruction has been repaired.

Thus, in accordance with embodiments herein, signals, event notifications, exceptions, etc., generated by hardware 110 can be used to avoid the need for heavy overhead processing and/or software instructions in software program 110 to check whether a lazy computation has been performed. In other words, one embodiment herein enables one or more lazy value computations without having to include inline code such as if-then-else instructions or other conditional processing instructions in software program 110 to explicitly check for the existence of an already-computed value or to compute a value if it has not already been computed. Instead, upon attempted access of a value from an invalid storage location, embodiments herein include computing the value and storing the computed value in a valid storage location.

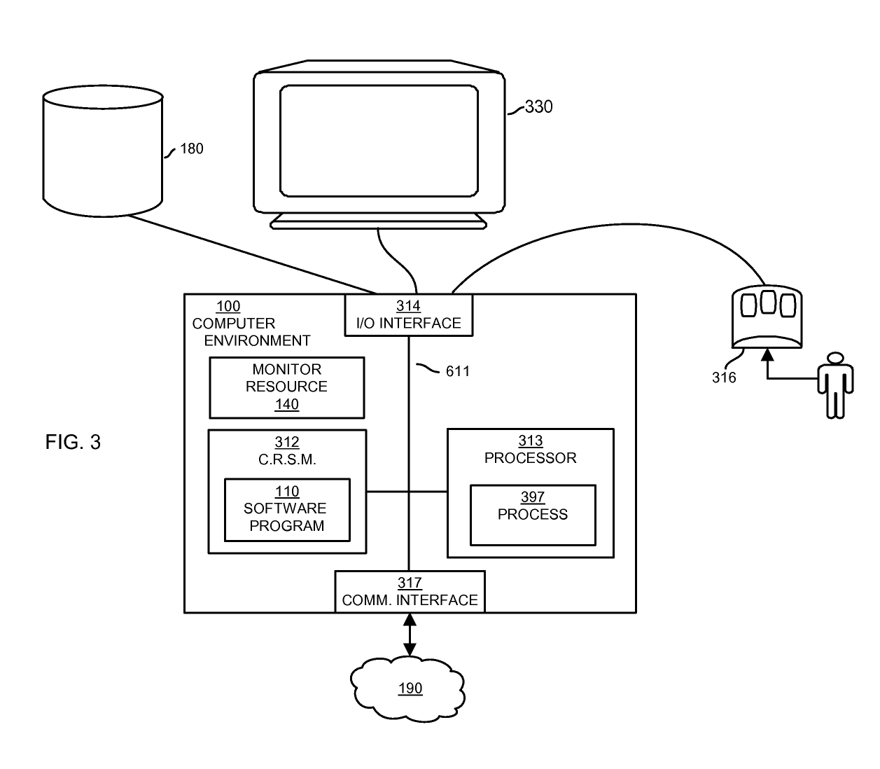

FIG. 3 is an example block diagram of a computer environment according to embodiments herein.

Computer environment 100 can be or include a computerized device such as a personal computer, workstation, portable computing device, console, network terminal, processing device, network device, etc., operating as a server, client, etc.

Note that the following discussion provides a basic embodiment indicating how to carry out functionality associated with handling of notifications associated with one or more failed software instructions. However, it should be noted that the actual configuration for carrying out the operations as described herein can vary depending on a respective application.

As shown, computer environment 100 of the present example includes an interconnect 311 that couples computer readable storage media 312 such as a non-transitory type of media in which digital information can be stored and retrieved, a processor 313 (e.g., hardware 115), I/O interface 314, and a communications interface 317.

I/O interface 314 provides connectivity to repository 180, display screen 330, peripheral devices 316, if such devices are present, such as a keyboard, a computer mouse, etc.

Computer readable storage medium 312 can be any suitable device such as memory, optical storage, hard drive, floppy disk, etc., such as a non-transitory storage media to store data such as software program 110.

Communications interface 317 enables computer environment 100 to communicate over network 190 to retrieve information from remote sources and communicate with other computers. I/O interface 314 also enables processor 313 to retrieve or attempt retrieval of stored information from repository 180.

As shown, computer readable storage media 312 can be encoded with software program 312 executed by processor 313 (e.g., hardware 115).

In an example embodiment, note that the monitor resource 140 also can be embodied to include a computer readable storage medium (e.g., a non-transitory media) for storing data and/or logic instructions. Monitor resource 140 also can include a processor to execute such instructions and carry monitoring operations as discussed herein. Accordingly, when executed, the code associated with monitor resource 140 can support processing functionality such as handling of instruction fault notifications such that the initially failing instructions can be executed on a subsequent pass without failing.

During operation of one embodiment, processor 313 accesses computer readable storage media 312 via the use of interconnect 311 in order to launch, run, execute, interpret or otherwise perform the instructions of software program 110 stored in computer readable storage medium 312. Execution of the software program 110 produces processing functionality in processor 313. In other words, the process 397 associated with processor 313 represents one or more aspects of executing software program 110 within or upon the processor 313 in the computer environment 100.

Those skilled in the art will understand that the computer system 314 can include other processes and/or software and hardware components, such as an operating system that controls allocation and use of hardware resources to execute software program 110.

In accordance with different embodiments, note that computer system may be any of various types of devices, including, but not limited to, a personal computer system, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, or in general any type of computing or electronic device.

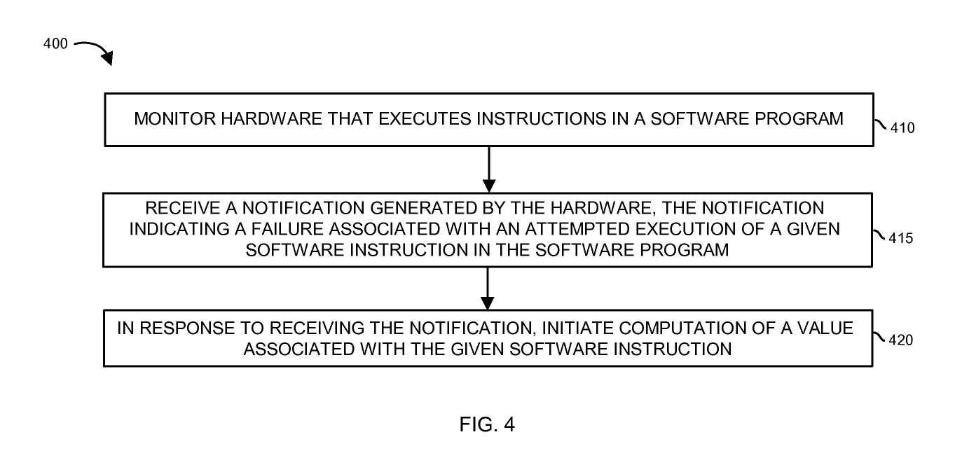

Functionality supported by resources in computer environment 100 will now be discussed via flowcharts in FIGS. 4-8. As discussed above, the monitor resource 140 and/or hardware 115 executing the software program 110 can be configured to execute the steps in the flowcharts as discussed below.

Note that there will be some overlap with respect to concepts discussed above for FIGS. 1 through 3. Also, note that the steps in the below flowcharts need not always be executed in the order shown. The steps can be executed in any suitable order.

FIG. 4 is a flowchart 400 illustrating a technique of performing a lazy computation according to embodiments herein.

In step 410, the monitor resource 140 monitors hardware 115. Hardware executes instructions in software program 110.

In step 415, the monitor resource 140 receives a notification such as event notification 125 generated by the hardware 115. In one embodiment, the event notification indicates occurrence of a failure associated with an attempted execution of a given software instruction in the software program 110.

In step 420, in response to receiving the notification 125, the monitor resource 140 initiates computation of a value associated with the given software instruction. In one embodiment, the computation of a value associated with the given instruction prevents occurrence of a subsequent failure of the instruction when executed on a subsequent pass.

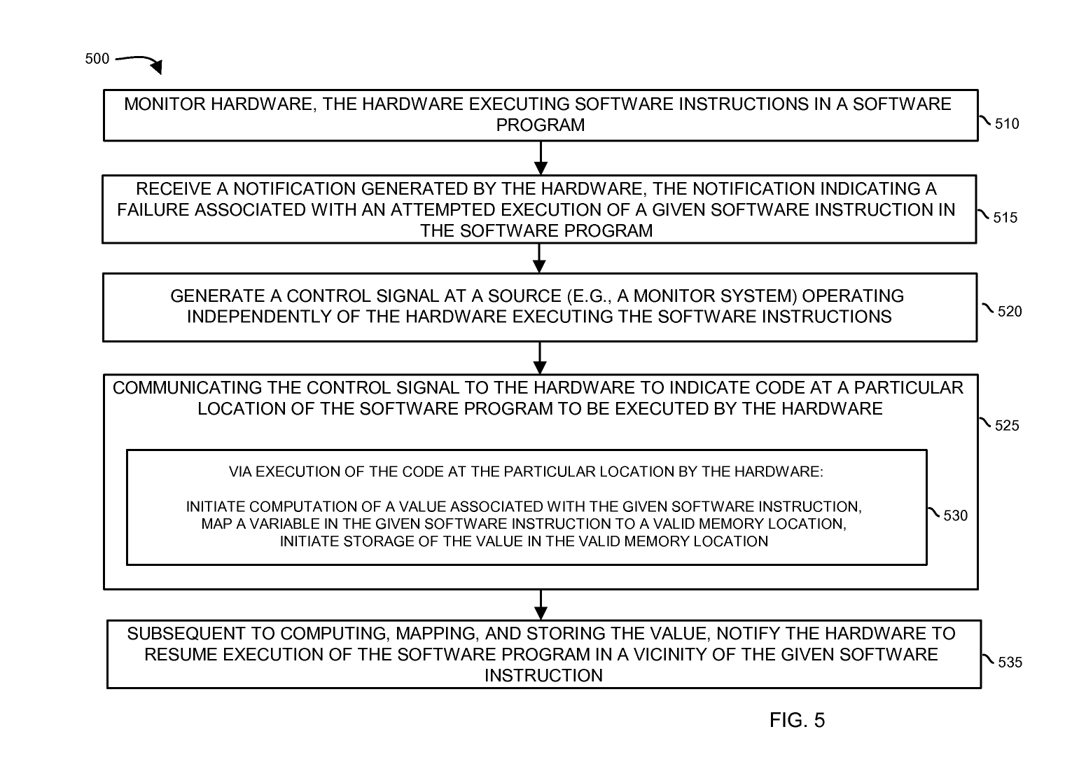

FIG. 5 is a flowchart 500 illustrating a technique of performing a computation associated with an instruction according to embodiments herein.

In step 510, the monitor resource 140 monitors hardware 115. Hardware 115 executes software instructions in software program 110.

In step 515, the monitor resource 140 receives a notification 125 generated by the hardware 115. The notification indicates a failure associated with an attempted execution of a given software instruction in the software program 110. In other words, the notification can indicate an inability to execute the given software instruction.

In step 520, the monitor resource 140 generates signal 150. In one embodiment, the monitor resource 140 operates independently of the hardware 115 executing the software program 110.

In step 525, the monitor resource 140 communicates the signal 150 to the hardware 115 to indicate code at a particular location of the software program 110 to be executed by the hardware 115.

In step 530, via execution of the code at the particular location by the hardware 115: the hardware 115 computes a value associated with the given software instruction, maps a variable in the given software instruction to a valid memory location, and initiates storage of the value in the valid memory location.

In step 535, subsequent to steps of computing, mapping, and storing the value, the monitor resource 140 notifies the hardware 115 to resume execution of the software program 110 in a vicinity of the given software instruction. In accordance with another embodiment, the hardware 115 re-attempts execution of the given instruction based on knowing that the given instruction failed during execution.

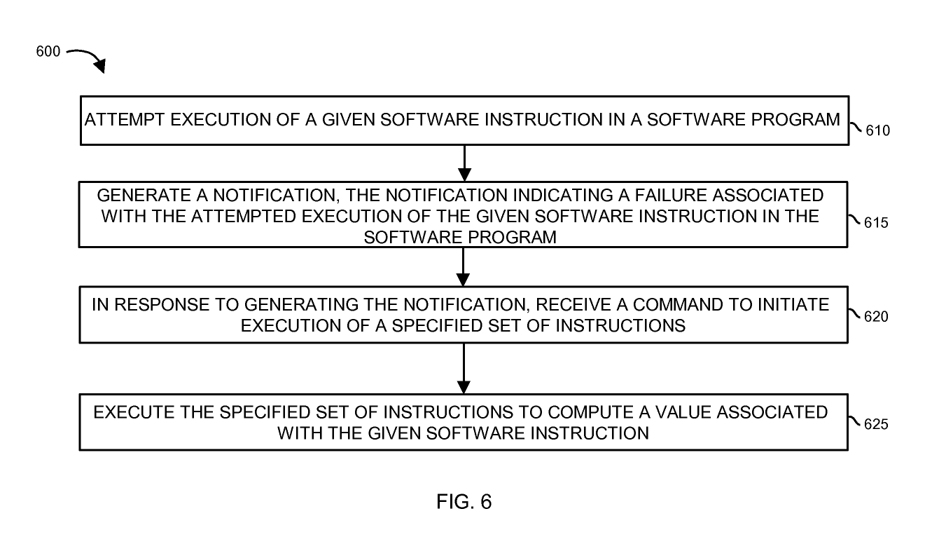

FIG. 6 is a flowchart 600 illustrating a technique of handling fault exceptions according to embodiments herein.

In step 610, the hardware 115 attempts execution of a given software instruction in a software program 110.

In step 615, the hardware 115 generates a notification 125. The notification 125 indicates a failure associated with the attempted execution of the given software instruction in the software program 110.

In step 620, in response to generating the notification 125, the hardware 115 receives a command from a source such as monitor resource 140 to initiate execution of a specified set of instructions.

In step 625, the hardware 115 executes the specified set of instructions to compute a value associated with the given software instruction.

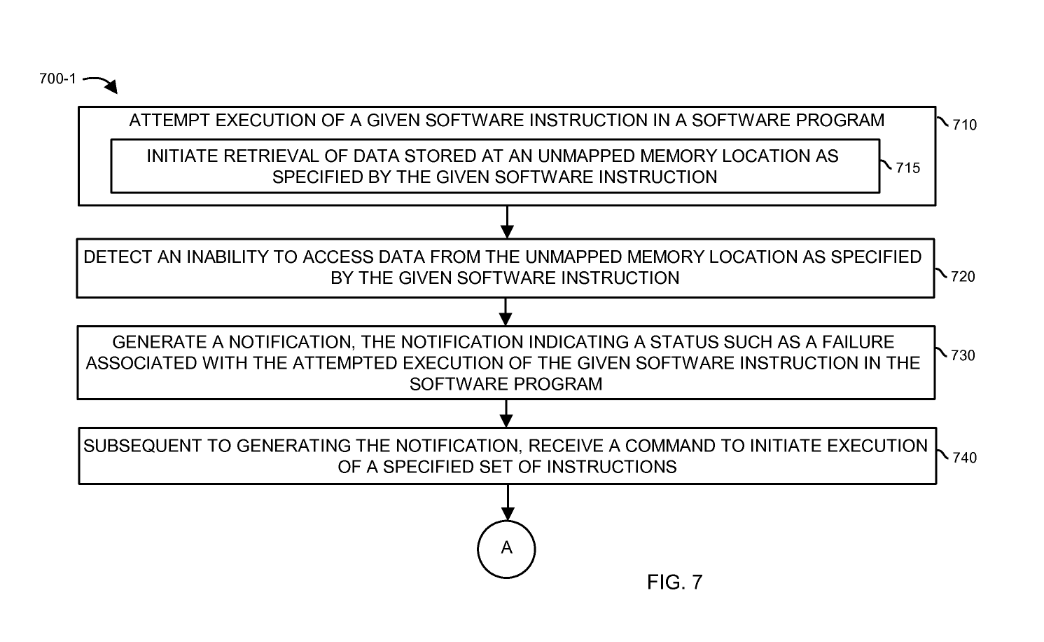

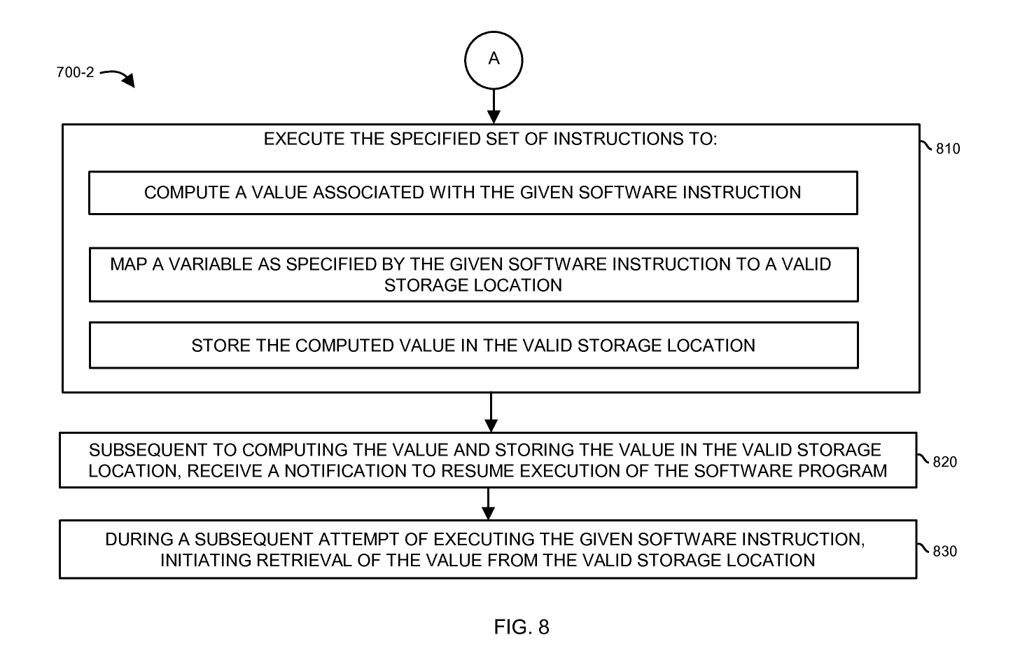

FIGS. 7 and 8 combine to form a flowchart 700 (e.g., flowchart 700-1 and flowchart 700-2) illustrating handling of a lazy computation according to embodiments herein.

In step 710 of flowchart 700-1, the hardware 115 attempts execution of a given software instruction in a software program 110.

In step 715, the hardware 115 initiates retrieval of data stored at an unmapped memory location as specified by the given software instruction.

In step 720, the hardware 115 detects an inability to access data from the unmapped memory location as specified by the given software instruction.

In step 730, the hardware 115 generates a notification, the notification indicating a status such as a failure associated with the attempted execution of the given software instruction in the software program 110.

In step 740, the hardware 115 subsequent to generating the notification, receives a command to initiate execution of a specified set of instructions in the software program 110 or other resource.

In step 810 of flowchart 700-2, the hardware 115 executes the specified set of instructions to: compute a value associated with the given software instruction, map a variable as specified by the given software instruction to a valid storage location, and store the computed value in the valid storage location.

In step 820, subsequent to computing the value and storing the value in the valid storage location, the hardware 115 receives a notification to resume execution of the software program 110.

In step 830, the hardware 115 during a subsequent attempt of executing the given software instruction, initiating retrieval of the value from the valid storage location.

As previously discussed, in one embodiment, the monitor resource or fault handler does not compute the required value. The monitor resource configures the state of the faulting program (e.g., switch program 110) such that, when resumed, it will be as if the faulting program had invoked a value computation subroutine. When execution of the Fault subroutine finishes, execution of the switch pro 110 will “return” to where the fault occurred and the faulting instruction will be reexecuted. This is because in practice the fault handler may be meaningfully separate from the faulting application such that the handler can't (or shouldn't due to re-entrancy, etc.) try to do the actual value computation.

Note again that techniques herein are well suited for execution of one or more lazy computations as described herein. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A method comprising:
monitoring hardware, the hardware executing software instructions in a software program;
receiving a notification generated by the hardware, the notification indicating a failure associated with an attempted execution of a given software instruction in the software program, the software instruction directing computation of a value that is not stored in memory; and
in response to receiving the notification, initiating computation of the value associated with the given software instruction.

2. The method as in claim 1, wherein initiating computation of the value includes:
via a control signal generated independent of executing the software instructions, redirecting the hardware to execute code located at a particular location in the software program to compute the value and store the value in a storage location.

3. The method as in claim 1, wherein initiating computation of the value includes:
via a control signal generated by a source operating independently of the hardware executing the software instructions, providing notification to the hardware to execute code located at a particular location in the software program to compute the value and store the value in a storage location.

4. The method as in claim 1 further comprising:
in response to receiving the fault notification, via a program control signal generated independent of executing the software instructions, initiating computation of the value and storage of the value in a storage location.

5. The method as in claim 1 further comprising:
subsequent to computing the value, notifying the hardware to resume execution of the given software instruction.

6. The method as in claim 1, wherein receiving the notification includes receiving location information indicating where the error occurred in the software program, the method further comprising:
generating a redirect signal notifying the hardware to initiate execution of instructions at a location as specified by the location information subsequent to initiating computation of the value.

7. The method as in claim 1 further comprising:
in response to receiving the fault notification:
mapping a variable in the given software instructions to a storage location; and
initiating storage of the value in the storage location.

8. The method as in claim 1, wherein receiving the notification occurs in response to the hardware detecting that a memory storage location as specified by the given software instruction is invalid.

9. The method as in claim 7, wherein receiving the notification occurs in response to the hardware detecting an inability to access data from a storage location as specified by the given software instruction.

10. A method comprising:
attempting execution of a given software instruction in a software program, the software instruction directing computation of a value that is not stored in memory;
generating a notification, the notification indicating a failure associated with the attempted execution of the given software instruction in the software program;
in response to generating the notification, receiving a command to initiate execution of a specified set of instructions in the software program; and
executing the specified set of instructions to compute the value associated with the given software instruction.

11. The method as in claim 10, wherein attempting execution of the given software instruction includes:
initiating retrieval of data stored at an unmapped memory location as specified by the given software instruction.

12. The method as in claim 11, wherein attempting execution of the given software instruction in the software program includes detecting an inability to access data from a storage location as specified by the given software instruction.

13. The method as in claim 10, wherein attempting execution of the given software instruction includes:
initiating retrieval of data stored at an invalid storage location as specified by the given software instruction.

14. The method as in claim 12 further comprising:
via execution of the specified set of instructions:
mapping a variable as specified by the given software instruction
to a valid storage location; and
storing the computed value in the valid storage location.

15. The method as in claim 12 further comprising:
subsequent to computing the value, receiving a notification to resume execution of the given software instruction.

16. The method as in claim 10, wherein attempting execution of the given software instruction in the software program includes detecting an inability to access data from a storage location as specified by the given software instruction.

17. The method as in claim 14 further comprising:
during a subsequent attempt of executing the given software instruction, initiating retrieval of the value from the valid storage location.

18. A non-transitory computer-readable storage medium having instructions stored thereon for processing data information, such that the instructions, when carried out by a processing device, cause the processing device to perform operations of:
monitoring hardware, the hardware executing software instructions in a software program;
receiving a notification generated by the hardware, the notification indicating a failure associated with an attempted execution of a given software instruction in the software program, the software instruction directing computation of a value that is not stored in memory; and
in response to receiving the notification, initiating computation of the value associated with the given software instruction.

19. The non-transitory computer-readable storage medium as in claim 18, wherein initiating computation of the value includes:
via a control signal generated independent of executing the software instructions, redirecting the hardware to execute code located at a particular location in the software program to compute the value and store the value in a storage location.

20. The non-transitory computer-readable storage medium as in claim 18, wherein initiating computation of the value includes:
via a control signal generated by a source operating independently of the hardware executing the software instructions, providing notification to the hardware to execute code located at a particular location in the software program to compute the value and store the value in a storage location.

21. The non-transitory computer-readable storage medium as in claim 18 further including instructions stored thereon that causes the processing device to perform operations of:
in response to receiving the fault notification, via a program control signal generated independent of executing the software instructions, initiating computation of the value and storage of the value in a storage location.

22. The non-transitory computer-readable storage medium as in claim 18 further including instructions stored thereon that causes the processing device to perform operations of:
subsequent to computing the value, notifying the hardware to resume execution of the given software instruction.

23. The non-transitory computer-readable storage medium as in claim 18, wherein receiving the notification includes receiving location information indicating where the error occurred in the software program, the method further comprising:
generating a redirect signal notifying the hardware to initiate execution of instructions at a location as specified by the location information subsequent to initiating computation of the value.

24. The non-transitory computer-readable storage medium as in claim 18 further including instructions stored thereon that causes the processing device to perform operations of:
in response to receiving the fault notification:
mapping a variable in the given software instructions to a memory location; and initiating storage of the value in the memory location.

25. The non-transitory computer-readable storage medium as in claim 18, wherein receiving the notification occurs in response to the hardware detecting that a memory storage location as specified by the given software instruction is invalid.

26. The non-transitory computer-readable storage medium as in claim 24, wherein receiving the notification occurs in response to the hardware detecting an inability to access data from a storage location as specified by the given software instruction.

27. A computer system comprising:
a processor;
a memory unit that stores instructions associated with an application executed by the processor; and
an interconnect coupling the processor and the memory unit, enabling the computer system to execute the application and perform operations of:
attempting execution of a given software instruction in a software program, the software instruction directing computation of a value that is not stored in memory;
generating a notification, the notification indicating a failure associated with the attempted execution of the given software instruction in the software program;
in response to generating the notification, receiving a command to initiate execution of a specified set of instructions; and
executing the specified set of instructions to compute the value associated with the given software instruction.
